(19) United States
(12) Patent Application Publication
(10) Pub. No.: US 2025/0318624 A1
(43) Pub. Date: Oct. 16, 2025

(54) FULLY AUTOMATIC NAIL DECORATING MACHINE AND NAIL DECORATING METHOD

(71) Applicant: SHANGHAI MEINAIER TECHNOLOGY CO., LTD., Shanghai (CN)

(72) Inventors: Tengxi QIU, Shanghai (CN); Yong XIANG, Shanghai (CN)

(21) Appl. No.: 19/252,571

(22) Filed: Jun. 27, 2025

Related U.S. Application Data
(63) Continuation of application No. PCT/CN2023/079604, filed on Mar. 3, 2023.

(30) Foreign Application Priority Data
Dec. 29, 2022 (CN) 202211708102.X

(51) Int. Cl. A45D 29/00

(52) U.S. Cl. CPC A45D 29/00; A45D 2029/005

(57) ABSTRACT

A fully automatic nail decorating machine, including a cabin body provided with a cabin door, where an inside of the cabin body is provided with at least one hand slot mechanism, the hand slot mechanism includes one or more finger slots; a visual recognition mechanism, arranged above the hand slot mechanism and including one or more cameras configured to photograph a finger placed in the hand slot mechanism, and transmit photographed information to a visual control module for data processing, to obtain a three-dimensional space model and position information of the finger; where a printing mechanism is arranged inside the cabin body, where the printing mechanism includes a three-way moving module and one or more printing nozzles fixed to the three-way moving module, and the one or more printing nozzles are driven by the three-way moving module to be positioned above the finger to perform spray printing to a nail.

### CROSS-REFERENCE TO RELATED APPLICATION

The present application is a U.S. Continuation of International Application PCT/CN2023/079604 filed on Mar. 3, 2023, which claims the benefit of and priority to Chinese patent application No. 202211708102.X filed with China National Intellectual Property Administration on Dec. 29, 2022, the content of the aforementioned applications is incorporated herein by reference in their entireties.

### TECHNICAL FIELD

The disclosure relates to the field of nail decorating machines, in particular to a fully automatic nail decorating machine and a nail decorating method.

### BACKGROUND

Nail decorating is a popular beauty method now, which mainly draws painted patterns on nails. The existing nail decorating methods generally use manual nail decorating, but in order to improve the efficiency and quality of nail decorating, the existing technology has developed a nail decorating machine, which is welcomed by many beauty shops.

### SUMMARY

In order to solve the above problems, the present disclosure provides following technical solutions. A fully automatic nail decorating machine, including a cabin body, where the cabin body is provided with a cabin door, an inside of the cabin body is provided with at least one hand slot mechanism, the hand slot mechanism includes one or more finger slots;
a visual recognition mechanism, arranged above the hand slot mechanism and including one or more cameras configured to photograph a finger placed in the hand slot mechanism, and transmit photographed information to a visual control module for data processing, so as to obtain a three-dimensional space model and position information of the finger;
where a printing mechanism is arranged inside the cabin body, where the printing mechanism includes a three-way moving module and one or more printing nozzles fixed to the three-way moving module, and the one or more printing nozzles are driven by the three-way moving module to be positioned above the finger to perform spray printing to a nail.

As a further description of the above technical solution, the hand slot mechanism further includes a pallet below the hand slot mechanism, and a position of the pallet close to a wrist is provided with a sensor configured to detect that the finger is completely placed in the hand slot mechanism.

As a further description of the above technical solution, a fixing mechanism is disposed inside each finger slot in the hand slot mechanism, and the fixing mechanism includes an inflatable air bag or a scalable strap.

As a further description of the above technical solution, two independent motors are arranged outside the finger slots of the hand slot mechanism, which are configured to drive the finger slots to rotate leftward and rightward and to raise or lower in height.

As a further description of the above technical solution, the visual recognition mechanism includes at least one of the cameras, and further includes a structured light module and a light filling module, where the structured light module and the light filling module are configured to improve photographing accuracy of the cameras.

As a further description of the above technical solution, the visual recognition mechanism further includes a moving block fixed to the cameras, the structured light module and the light filling module, and the moving block is driven by a screw rod penetrating inside the moving block and a driving motor connected externally to the screw rod to realize an axial movement along the screw rod.

As a further description of the above technical solution, the one or more printing nozzles are fixed to an outside of a mounting board, and a material receiving box having a length same as a total length of the one or more printing nozzles is provided below the one or more printing nozzles;
where nozzle placement boxes having a number matching a number of the one or more printing nozzles are further provided below the one or more printing nozzles, and the one or more printing nozzles are placed in the nozzle placement boxes in a stopped state.

As a further description of the above aspect, the three-way moving module includes an X-direction moving module, a Y-direction moving module, and a Z-direction moving module, where the X-direction is a width direction of the cabin body, the Y-direction is a length direction of the cabin body, and the Z-direction is a height direction of the cabin body.

As a further description of the above technical solution, two sides of an outer shell of each of the one or more printing nozzles are provided with sensor resilient strips, and an operation of the Y-direction moving module is stopped after the sensor resilient strips are in contact with an inner wall of the cabin body.

As a further description of the above technical solution, control modules are provided in the hand slot mechanism, the visual recognition mechanism and the printing mechanism.

As a further description of the above technical solution, the hand slot mechanism further includes a first thumb slot provided on one side of the one or more finger slots.

As a further description of the above technical solution, the hand slot mechanism further includes a second thumb slot provided on an other side of the one or more finger slots.

As a further description of the above technical solution, the hand slot mechanism further includes a finger placement slot provided on a side of the second thumb slot away from the one or more finger slots.

As a further description of the above technical solution, the fully automatic nail decorating machine further includes a disinfection mechanism disposed above the hand slot mechanism and including a disinfection lamp tube configured to disinfect the hand slot mechanism after finishing nail decorating.

As a further description of the above technical solution, the hand slot mechanism further includes a multi-functional plate.

As a further description of the above technical solution, the fully automatic nail decorating machine further includes a robotic arm disposed inside the cabin body.

The disclosure further discloses a nail decorating method of a fully automatic nail decorating machine, applicable to the above-mentioned fully automatic nail decorating machines, and including the following steps:
S1, resetting each component in the nail decorating machine to open the cabin door of the cabin body;
S2, informing a user to put one or more fingers into the hand slot mechanism through a voice playback module;
S3, fixing the fingers by actuating a fixing mechanism after a sensor of the hand slot mechanism detects that one or more fingers are put in, performing a first scan by the visual recognition mechanism after the visual recognition mechanism moves to a position above the hand slot mechanism to calculate rotation angles and heights of the one or more fingers, calculating adjustment data and transmitting the adjustment data to the hand slot mechanism to adjust postures of the fingers, performing a second scan to identify whether a nail decorating operating condition is met, informing the user to re-insert one or more fingers to repeat steps S2 to S3 when the nail decorating operating condition is not met, and entering into a next step when the nail decorating operating condition is met;
S4, performing photographing by the visual recognition mechanism to the fingers after the adjustment to the fingers are completed, segmenting nails into nail decorating regions using an algorithm, adjusting sizes and inclinations of nail decorating patterns through an algorithm to associate the nail decorating patterns with nail decorating regions and generate a whole nail decorating pattern, and performing a X-Y-Z three-dimensional coordinate processing in combination with point cloud information of one or more fingers processed by the visual control module to generate nail decorating data and transmit the nail decorating data to the printing mechanism; and
S5, spraying, by the printing nozzles, the nails by controlling the three-way moving module to drive the printing nozzles to move to a position above the hand slot mechanism after the printing mechanism receives the nail decorating data, so as to realize nail decorating;
where in steps S1 to S5, control modules of the hand slot mechanism, the visual recognition mechanism and the printing mechanism are controlled by a main control module, so as to realize movement execution of each mechanism.

As a further description of the above technical solution, the main control module further includes a safety protection judgment module, where data is transmitted to the main control module when the safety protection judgment module detects data abnormality, and each mechanism is controlled to stop operation or perform protection actions by the main control module.

As a further description of the above technical solution, the nail decorating machine is further provided with a human-computer interaction screen, where the nail decorating method includes:
receiving a nail decorating confirmation signal by the nail decorating machine through the human-computer interaction screen, and generating a nail decorating machine feature code by the human-computer interaction screen;
scanning the human-computer interaction screen by the user using a mobile device to obtain the feature code, binding the user, an order and the nail decorating machine, and displaying the order in the human-computer interaction screen;
performing a nail decorating operation after the human-machine interaction screen receives order confirmation information.

### Beneficial Effects

Compared with the existing technology, the disclosure provides a fully automatic nail decorating machine and a nail decorating method, which have the following beneficial effects.

Through the matching use of the hand slot mechanism, the visual recognition mechanism and the printing mechanism, the disclosure can automatically adjust the finger to the nail front of the finger to be sprayed faces upward after placing one or more fingers in the hand slot mechanism, and simultaneously adjust the height of the nail to the same height, simultaneously measure and recognize the three-dimensional coordinate information of the nail through the visual recognition mechanism, and transmit it to the control module of the printing mechanism, and the printing mechanism moves to the top of the nail, so as to achieve the effect of fully automatic nail decorating. Moreover, the hand slot mechanism can fix the fingers during nail decorating to ensure the precision of nail decorating and improve the nail decorating effect. At the same time, the hand slot mechanism is more ergonomic, which improves the comfort of nail decorating.

### BRIEF DESCRIPTION OF THE DRAWINGS

FIG. 1 is a schematic structural diagram of a whole machine according to the present disclosure;

FIG. 2 is a schematic structural diagram of the whole machine according to the present disclosure from another perspective;

FIG. 3 is a schematic structural diagram of the whole machine according to the present disclosure from another perspective;

FIG. 4 is a schematic diagram of a hand slot mechanism according to the present disclosure;

FIG. 5 is a schematic diagram of an airbag in a hand slot mechanism of the present disclosure;

FIG. 6 is a schematic view of a visual recognition mechanism according to the present disclosure;

FIG. 7 is a schematic view of a printing mechanism according to the present disclosure;

FIG. 8 is a flowchart of a nail decorating method according to the present disclosure.

### REFERENCE NUMERALS

1, cabin body; 2, hand slot mechanism; 3, visual recognition mechanism; 4, printing mechanism; 5, disinfection mechanism; 201, four-finger slot; 202, first thumb slot; 203, second thumb slot; 204, four-finger placement slot; 205, pallet; 206, airbag; 301, camera; 302, moving block; 303, screw rod; 304, driving motor; 401, printing nozzle; 402, mounting board; 403, material receiving box; 404, nozzle placement box; 405, X-direction moving module; 406, Y-direction moving module; 407, Z-direction moving module; 408, Sensor resilient strips; 5, disinfection mechanism; 501, disinfection lamp tube; 6, cabin door.

### DETAILED DESCRIPTION

Some embodiments of the present disclosure will be described in detail below with reference to the accompanying drawings. Obviously, the described embodiments are only a part of the embodiments of the present disclosure, rather than all of them. Based on embodiments in the present disclosure, all other embodiments obtained by those skilled in the art without creative labor fall within the scope of the present disclosure.

Nail decorating is a popular beauty method now, which mainly draws painted patterns on nails. The existing nail decorating methods generally use manual nail decorating, but in order to improve the efficiency and quality of nail decorating, the existing technology has developed a nail decorating machine, which is welcomed by many beauty shops.

A system and method for nail manipulation as provided in Publication No. CN105939633B may be created based on a real-time scanning method for the nail surface of a particular person (which may utilize nail 3D pattern recognition). By implementing accurate scanning techniques for the nails, the present disclosure also aims to extend the maintenance intervals for handmade nails. In addition, the present disclosure also reduces the health risks related to UV or microwave radiation to the skin, and the potential risk of cancer as a consequence, i.e. the radiator can be directed very close to the nail area to be manipulated due to the precise scanning or imaging method (shape information providing means), thereby creating a very limited exposed skin area, thereby also reducing the radiation dose. However, in the coordination of the whole nail decorating machine, it is inevitable that human hands will shake and move due to many factors in the process of nail decorating. In this case, the nail decorating machine will lead to the partial printing of the nail decorating pattern during the operating process, which cannot be just on the front surface of the nail, resulting in the unsatisfactory nail decorating effect of the nail decorating machine.

Accordingly, an object of the present application is to provide a fully automatic nail decorating machine and a nail decorating method to improve the nail operation system and method in the related art, and particularly to solve the problem that the printing effect of a nail decorating pattern is not satisfactory.

### Embodiment 1

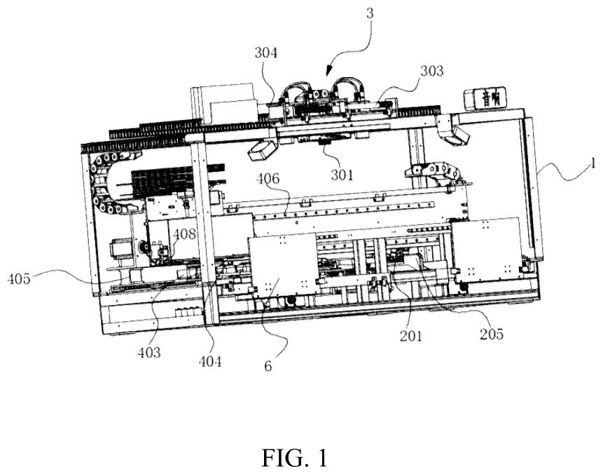

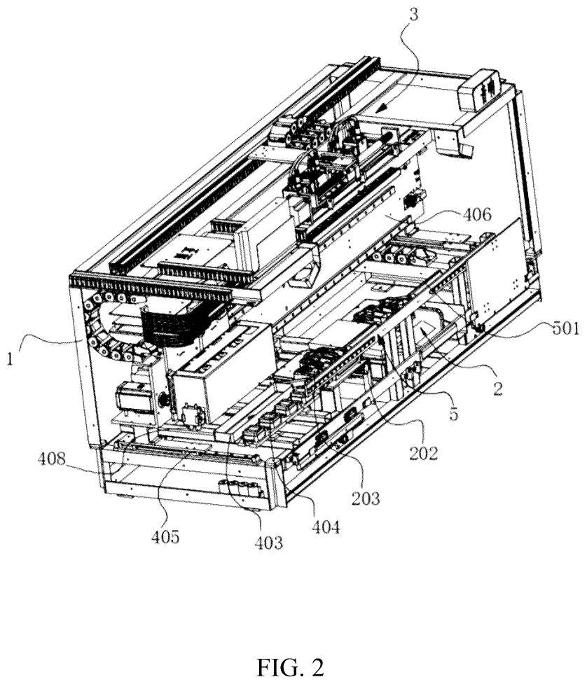

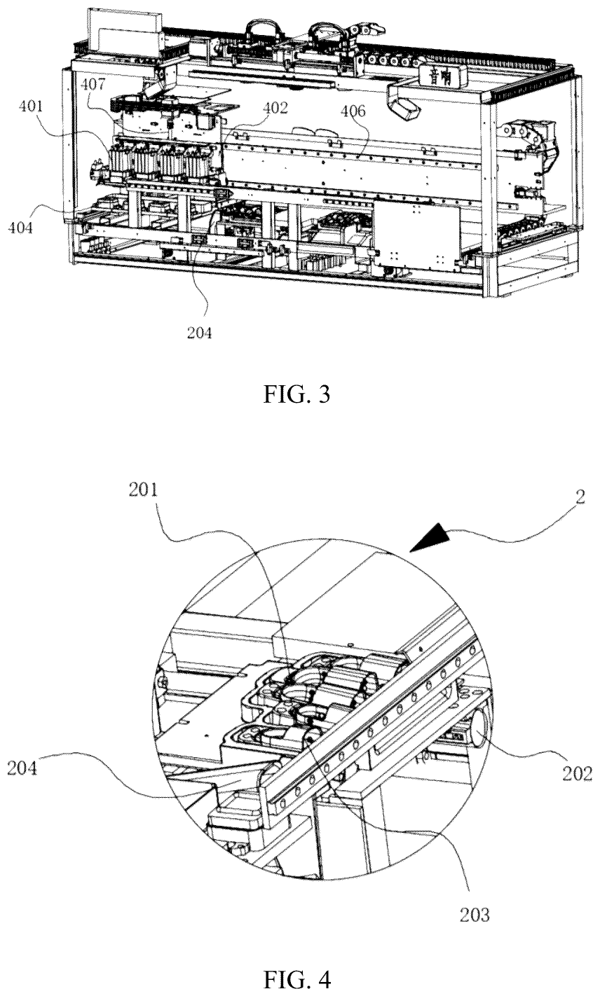

Referring to FIG. 1 to FIG. 6, a fully automatic nail decorating machine includes a cabin body 1, which is generally shaped as a square box, and may also have other shapes in other embodiments. A cabin door 6 is provided on the cabin body 1, and the cabin door 6 can be driven to rotate by a gear by a motor, thereby driving a toothed rod arranged at the bottom of the cabin door 6 to realize automatic opening and automatic closing. An arm detection device, a touch screen, an emergency stop button and a horn are also installed on both sides of the cabin door. Users can interact with the machine through the touch screen to start nail decorating or stop the machine. When the sensor in the arm detection device detects that the arm is approaching, it will control the equipment in the machine to stop through the main control module and broadcast it through the speaker voice to protect the user's safety. The emergency stop button can be pressed at any time, and when the button is pressed, the protection action is performed, specifically including the stop action of all movable mechanisms inside the nail decorating machine, and one or more fingers of the user are immediately released to ensure the safety of the user, which will not be repeated herein as existing technologies. In one embodiment, at least one hand slot mechanism 2 may be provided inside the cabin body 1, i.e. close to the cabin door 6. In one embodiment, two hand slot mechanisms 2 may be provided. Optionally, the two hand slot mechanisms 2 may be arranged symmetrically to conform to the ergonomic design when the user's hands are inserted. In one embodiment, the hand slot mechanism 2 may include one or more finger slots 201. Additionally, the hand slot mechanism 2 may include a first thumb finger slot 202 provided on one side of one or more finger slots 201. Additionally, the hand slot mechanism 2 may include a second thumb slot 203 provided on the other side of the one or more finger slots 201. Additionally, the hand slot mechanism may include a finger placement slot 204 disposed on a side of the second thumb slot 203 away from the one or more finger slots 201. In one embodiment, the hand slot mechanism 2 may include six finger slots and one four finger placement slot 204. When performing nail decorating on four nails except the thumb, four fingers can be inserted into four finger slots 201, and the thumb is inserted into the first thumb finger slot 202. After performing nail decorating on the other four nails, four fingers are placed into the side finger placement slot 204, and the thumb is placed into the second thumb finger slot 203, so that the nail of the thumb can be faced upward to perform the nail decorating operation to the thumb. The hand slot mechanism 2 is used for placing the fingers and positioning the fingers when performing nail decorating on the four fingers and the thumb, so as to facilitate the subsequent spray printing;

The visual recognition mechanism 3 is arranged above the hand slot mechanism 2, and includes one or more cameras 301, two groups of cameras 301 may be arranged, and the visual control module may be used to process data captured by the camera 301, and after the camera 301 captures a finger placed in the hand slot mechanism 2, the captured information is transmitted to the visual control module for data processing, so as to obtain a three-dimensional space model of the finger and position information of the finger;

The inside of the cabin body 1 is provided with a printing mechanism 4, the printing mechanism 4 includes a three-way moving module and one or more printing nozzles 401 fixed on the three-way moving module, four printing nozzles 401 are provided in this embodiment, and the colors sprayed by the four printing nozzles 401 can be different, specifically determined by an externally connected ink bin, the ink bin and the printing nozzles 401 are connected by a pipeline, and the four printing nozzles 401 are all set downward, and the three-way moving module includes X direction, Y direction and Z direction, so that the printing nozzles 401 can be driven to move to any position in the cabin body 1. The three-way moving module drives one or more printing nozzles 401 to move to a position above the fingers to perform spray printing to the nails.

Through the cooperative use of the hand slot mechanism 2, the visual recognition mechanism 3 and the printing mechanism 4, after one or more fingers desired to carry out nail decorating are placed in the hand slot mechanism 2, the fingers can be automatically adjusted to the nail front of the finger to be sprayed face upward, and the height of the nail can be adjusted to the same height at the same time, and the three-dimensional coordinate information of the nail is measured and recognized by the visual recognition mechanism 3, and transmitted to the control module of the printing mechanism 4. The printing mechanism 4 moves to a position above the nails and sprays in sequence, thereby achieving a fully automatic nail decorating effect.

Additionally, the fully automatic nail decorating machine may include a disinfection mechanism 5, which is arranged above the hand slot mechanism 2, and includes a disinfection lamp tube 501, the disinfection lamp tube 501 is an ultraviolet lamp tube, and the disinfection mechanism 5 further includes a control module for controlling the disinfection lamp tube 501, which is used for disinfection of the hand slot mechanism 2 after the nail decorating is finished, so as to ensure the hygiene and safety of the nail decorating process.

In some embodiments, one or more of the hand slot mechanism 2, the visual recognition mechanism 3, the printing mechanism 4, and the disinfection mechanism 5 may be provided with a control module.

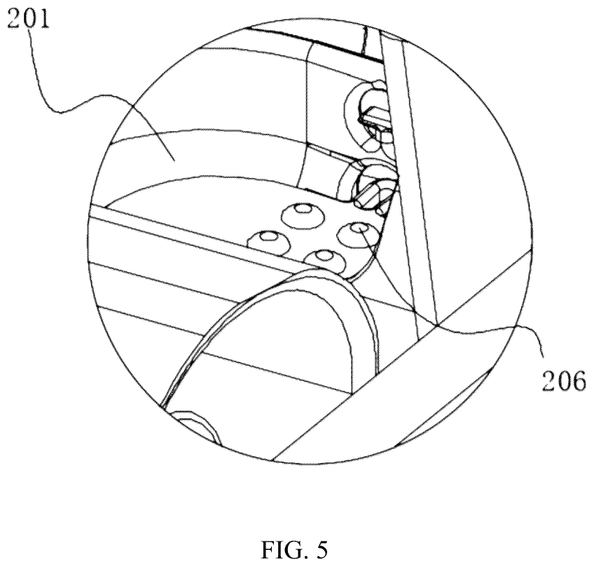

Referring to FIG. 4 to FIG. 5, the hand slot structure 2 is specifically described. The hand slot structure 2 includes a pallet 205 at the bottom, and a sensor is arranged at the position near the wrist of the pallet 205. When one or more fingers are completely inserted into the hand slot mechanism 2, the wrist is fitted with the sensor. At this time, the sensor transmits the signal to the air supply pump of the airbag 206, so that the air supply pump supplies air to the airbag 206, and the airbag 206 is expanded. By cooperating the airbag 206 with the inner walls of each finger slot, the fingers can be clamped and fixed to facilitate subsequent spray printing, thereby effectively reducing the occurrence of inaccurate printing caused by finger shaking. Additionally, a pressure sensor is arranged inside each finger slot to detect the pressure exerted on the fingers, thereby ensuring comfort level while fixing fingers of the user and preventing fingers of the user from compressive injuries.

The shape of each finger slot is approximately a hollow cylindrical structure fitting with the shape of the finger, and a slot is provided above the finger slot, that is, near the nail, for the external printing mechanism 4 to spray the nail decorating patterns through the printing nozzles 401, and each finger slot of the four finger slots 201 can be controlled by a micro motor and a control module to realize the control of the four fingers at the same height. A micro motor to control the rotation angle of the finger slot is provided outside the first thumb slot 202, to adjust the inclined thumb to make the front of the nail face upward, thereby facilitating to spray nail decorating patterns.

Of course, instead of the airbag, a scalable strap or the like may be provided in the finger slot, and the present application does not limit the implementation of the fixing mechanism for fixing the finger in the finger slot.

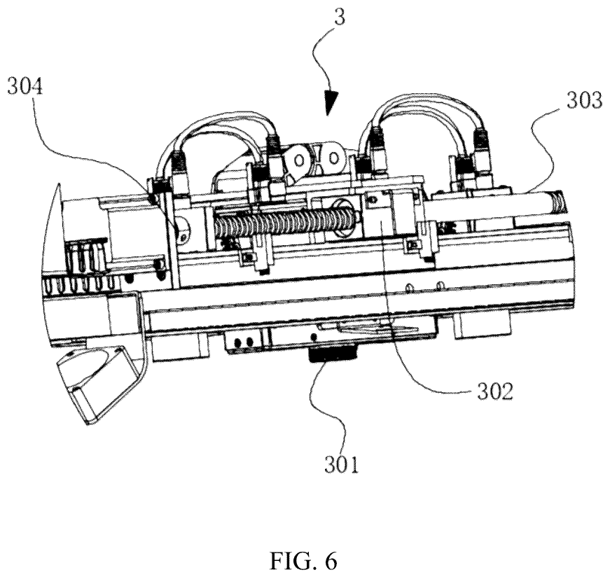

Referring to FIG. 6, the visual recognition mechanism 3 is specifically described. The visual recognition structure 3 includes a camera 301 as an information acquisition device, and further includes a structured light module and a light filling module. The light filling module is fill light lamps provided on the left and right sides of the camera 301. During photographing, the left and right cameras 301 take photos at a specific angle, and the structured light module and the light filling module can be used to assist in improving the photographing accuracy of the camera. The camera 301 transmits relevant data to the visual control module after taking a photo. The visual control module calculates the point cloud information of one or more fingers in the three-dimensional space through an algorithm based on the captured photo (as existing technologies, the relevant algorithms for point clouds are not repeated herein), and further calculates the height and the inclination angle of each finger through the point cloud in order for the hand slot mechanism to perform adjustments. Photographing is performed again after the adjustment, then the mechanical adjustment result is verified, and then the next step is entered after meeting the requirements of nail decorating operation, that is, after the finger is adjusted in place, the neural network algorithm is used to segment the nail, and the nail decorating pattern is adjusted in size and inclined into the nail area through the algorithm to generate the nail decorating pattern. After the nail decorating pattern is generated, X-Y-Z three-dimensional coordinate processing is performed in combination with the point cloud information of one or more fingers to generate nail decorating data, which is used to guide the printing mechanism to perform printing operation. When the two hand slot mechanisms 2 are provided, the visual recognition mechanism 3 is further provided with a moving block 302, the camera 302 and the visual control module are fixed on the moving block 302, and the moving block 302 realizes the movement of the camera 301 along the axial direction of the screw rod 303 by driving the screw rod 303 penetrating the inside of the moving block 302 and the driving motor 304 connected externally to the screw rod 303, so that the two hand slot mechanisms 2 are respectively photographed and processed.

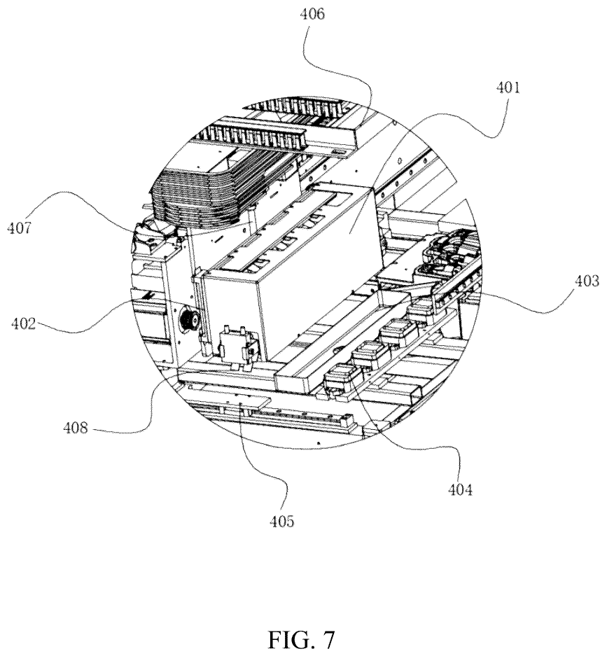

Referring to FIG. 7, the printing mechanism 4 is specifically described. The printing mechanism 4 includes one or more printing nozzles 401, the color in the one or more printing nozzles 401 can be adjusted according to the color in the ink bin. The one or more printing nozzles 401 are fixed on the mounting board 402 by a fixed bracket, the mounting board 402 is slidably connected to the external vertical slider, and controlled to move up and down by a linear motor, thereby enabling one or more printing nozzles 401 to move up and down along the Z-axis direction, where the Z-axis direction is the height direction of the cabin body 1. The vertical slider is fixed on the external horizontal sliding rail, and the pulley drives the Z-direction moving module 407 to move along the Y-direction (the Y-direction is the length direction of the cabin body). The horizontal rail is fixed on another rail below, and the linear motor drives one or more printing nozzles 401, the Y-direction moving module 406, and the Z-direction moving module 407 to move along the X-direction (the X-direction is the width direction of the cabin body 1). Through the cooperation of the X-direction moving module 406, Y-direction moving module 406, and Z-direction moving module 407, one or more printing nozzles 401 can be moved to any position inside the cabin body 1, so as to print manicure patterns on the nails in the hand slot mechanism 2.

When the printing mechanism 4 is not in use, one or more printing nozzles 401 are placed in one or more nozzle placement boxes 404, and sponges are placed in the nozzle placement boxes 404 for absorbing excess paint. When in use, one or more printing nozzles 401 are driven by the three-way moving module to move above the material receiving box 403. The material receiving box 403 is a tank body with an open upper part, and the length of the material receiving box 403 is the same as the total width of the one or more printing nozzles 401. The one or more printing nozzles 401 are firstly moved to a position above the material receiving box 403 before operation. The one or more printing nozzles 401 are controlled to spray a portion of the coating first, and then are moved to a position above the hand slot mechanism 2 to perform nail decorating operations, thereby, through the process, preventing clogged coatings in the printing nozzles from affecting the quality of nail decorating patterns in subsequent printing.

Operating principle of the printing mechanism 4 is as follows. After receiving the nail decorating data transmitted by the visual recognition mechanism transmission 3, the control module of the printing mechanism 4 moves to the top of the hand slot mechanism 2 according to the nail decorating data content through the three-way moving module to sequentially print nail decorating patterns on the fingers.

In some embodiments, the hand slot mechanism may further include a multi-functional plate for placing paper sheets for self-checking and/or calibrating the printing mechanism by printing a given pattern on the paper sheets prior to a nail decorating operation.

In some embodiments, the fully automatic nail decorating machine may further include a robotic arm, and the robotic arm is disposed inside the cabin body.

In some embodiments, the multi-functional plate can also be used for pattern making of other articles, for example, it can be used for pattern making of mobile phone cases, etc., and the present application does not limit this.

In some embodiments, the multi-functional plate may be pre-loaded with a pattern. In this case, the multi-function board may be a display device capable of displaying a given pattern, such as an ink screen, an LED display screen, an OLED screen, or the like, and the present application does not make any limitation thereon.

Additionally, as a supplement to the printing mechanism 4, the fully automatic nail decorating machine may further include an actuator for performing operations such as diamond setting, diamond sticking, pattern sticking, chiseling, grinding, and the like on the nails of one or more fingers of the user, including but not limited to a robotic arm. By way of example and not limitation, a robotic arm may be disposed inside the cabin body for manipulation of one or more fingers of a user. Those skilled in the art will readily appreciate that, in addition to the printing mechanism 4, any other suitable actuator may be provided in a fully automatic nail decorating machine as disclosed herein to perform aesthetic processing operations on one or more fingers and/or nails thereon of a user.

### Example 2

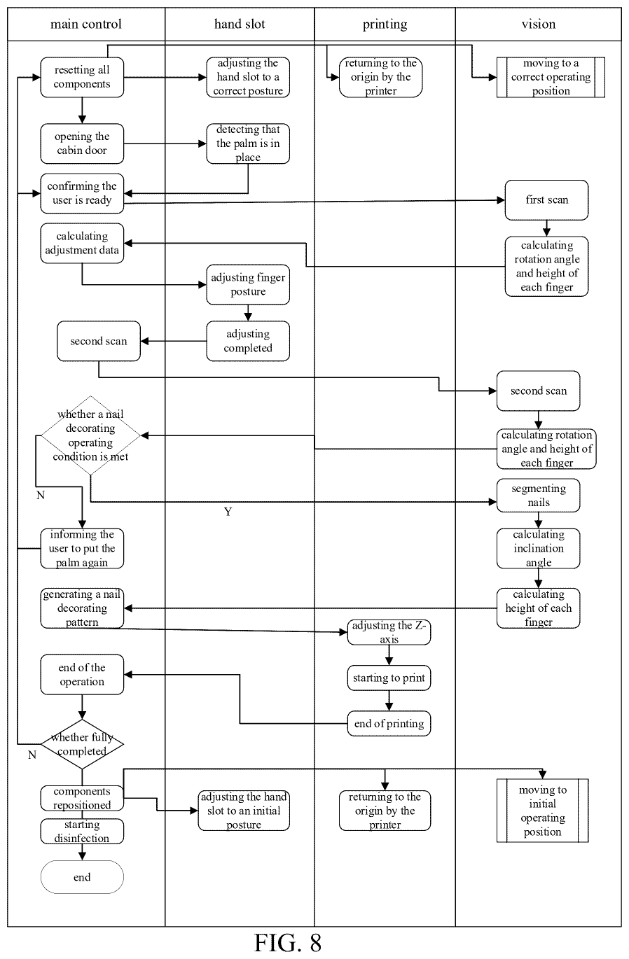

Referring to FIG. 8, a nail decorating method of a fully automatic nail decorating machine, the specific steps include: S1, resetting all components in the nail decorating machine and opening the cabin door 6 of the cabin body 1; where the resetting all components in the nail decorating machine includes: adjusting the hand slot mechanism 2 to a correct posture, resetting the printing mechanism 4 to a far point, moving the visual recognition mechanism 3 to a position above the hand slot mechanism 2 inserted with one or more fingers;
S2, informing a user to put one or more fingers into the hand slot mechanism 2 through a voice playback module;
S3, fixing the fingers by actuating a fixing mechanism (such as an inflatable airbag 206 or a scalable strap, etc.) after a sensor of the hand slot mechanism 2 detects that one or more fingers are put in, performing a first scan by the visual recognition mechanism 3 after the visual recognition mechanism 3 moves to a position above the hand slot mechanism 2 to calculate rotation angles and heights of the one or more fingers, calculating adjustment data and transmitting the adjustment data to the hand slot mechanism 2 to adjust postures of the fingers, performing a second scan to identify whether a nail decorating operating condition is met, informing the user to re-insert one or more fingers to repeat steps S2 to S3 when the nail decorating operating condition is not met, and proceed to next step when the nail decorating operating condition is met;
S4, performing photographing by the visual recognition mechanism 3 to the fingers after the adjustment to the fingers are completed, segmenting nails into nail decorating regions using an algorithm, adjusting sizes and inclinations of nail decorating patterns through an algorithm to associate the nail decorating patterns with nail decorating regions and generate a whole nail decorating patterns, and performing a X-Y-Z three-dimensional coordinate processing in combination with point cloud information of one or more fingers processed by the visual control module to generate nail decorating data and transmit the nail decorating data to the printing mechanism 4; and;
S5, spraying, by the printing nozzles 401, the nails by controlling the three-way moving module to drive the printing nozzles 401 to move to a position above the hand slot mechanism 2 after the printing mechanism 4 receives the nail decorating data so as to realize nail decorating, and perform resetting by each mechanism after the nail decorating is completed and performing disinfection by the disinfection mechanism 5.

The nail decorating machine is also provided with a man-machine interaction screen, the screen is a touchable screen, the nail decorating machine receives and confirms the nail decorating signal through the man-machine interaction screen, and the man-machine interaction screen is generated into the nail decorating machine feature code;

The user uses the mobile device to scan the human-computer interaction screen to obtain a feature code, bind the user, the order and the nail decorating machine, and display the order in the human-computer interaction screen;

After receiving the order confirmation information, the man-machine interaction screen executes the nail decorating operation.

In steps S1-S5, the control modules of each of the hand slot mechanism 2, the visual recognition mechanism 3 and the printing mechanism 4 are controlled by the main control module, so as to realize the movement operation of each mechanism. The main control module further includes a safety protection judgment module, which is responsible for managing the safety protection of the nail decorating machine. The safety protection module of the safety protection judgment module includes collision detection module based on computer vision, soft contacting touch protection devices (i.e., sensor resilient strips 408) located on both sides of the printing nozzles, an arm detection device located at the cabin door 6, a finger detection device located at the hand slot mechanism 2, and a manually controlled emergency stop button, thereby forming multiple safety protections. The main control module needs to acquire the information of the above device or sensor in real time to perform safety logic judgment. Protection actions are immediately performed when there is contact risk or contact has occurred. When data abnormality is detected, the safety protection judgment module transmits data to the main control module, to control the control modules of each mechanism through the main control module, thereby controlling each mechanism to stop operation or perform protection actions, so as to realize the protection of human body and avoid the occurrence and occurrence of dangerous situations.

While embodiments of the present disclosure have been shown and described, it will be understood by those of ordinary skill in the art that numerous changes, modifications, substitutions and variations may be made to these embodiments without departing from the principles and spirit of the disclosure, the scope of which is defined by the appended claims and their equivalents.

What is claimed is:

1. A fully automatic nail decorating machine, comprising a cabin body, wherein the cabin body is provided with a cabin door, an inside of the cabin body is provided with at least one hand slot mechanism, the hand slot mechanism comprises one or more finger slots;
a visual recognition mechanism, arranged above the hand slot mechanism and comprising one or more cameras configured to photograph a finger placed in the hand slot mechanism, and transmit photographed information to a visual control module for data processing, so as to obtain a three-dimensional space model and position information of the finger;
wherein a printing mechanism is arranged inside the cabin body, wherein the printing mechanism comprises a three-way moving module and one or more printing nozzles fixed to the three-way moving module, and the one or more printing nozzles are driven by the three-way moving module to be positioned above the finger to perform spray printing to a nail.

2. The fully automatic nail decorating machine according to claim 1, wherein the hand slot mechanism further comprises a lower pallet, and a position of the pallet close to a wrist is provided with a sensor configured to detect whether the finger is completely placed in the hand slot mechanism.

3. The fully automatic nail decorating machine according to claim 1, wherein a fixing mechanism is disposed inside each finger slot in the hand slot mechanism, and the fixing mechanism comprises an inflatable air bag or a scalable strap.

4. The fully automatic nail decorating machine according to claim 1, wherein two independent motors are arranged outside the finger slots of the hand slot mechanism, which are configured to drive the finger slots to rotate leftward and rightward and to raise or lower in height.

5. The fully automatic nail decorating machine according to claim 1, wherein the visual recognition mechanism comprises at least one of the cameras, and further comprises a structured light module and a light filling module, wherein the structured light module and the light filling module are configured to improve photographing accuracy of the cameras.

6. The fully automatic nail decorating machine according to claim 5, wherein the visual recognition mechanism further comprises a moving block fixed with the cameras, the structured light module and the light filling module, and the moving block is driven by a screw rod penetrating inside the moving block and a driving motor connected externally to the screw rod to realize an axial movement along the screw rod.

7. The fully automatic nail decorating machine according to claim 1, wherein the one or more printing nozzles are fixed to an outside of a mounting board, and a material receiving box having a length same as a total length of the one or more printing nozzles is provided below the one or more printing nozzles;
wherein nozzle placement boxes having a number matching a number of the one or more printing nozzles are further provided below the one or more printing nozzles, and the one or more printing nozzles are placed in the nozzle placement boxes in a deactivation state.

8. The fully automatic nail decorating machine according to claim 7, wherein the three-way moving module comprises an X-direction moving module, a Y-direction moving module, and a Z-direction moving module, wherein the X-direction is a width direction of the cabin body, the Y-direction is a length direction of the cabin body, and the Z-direction is a height direction of the cabin body.

9. The fully automatic nail decorating machine according to claim 8, wherein two sides of an outer shell of each of the one or more printing nozzles are provided with sensor resilient strips, and an operation of the Y-direction moving module is stopped after the sensor resilient strips are contacted with an inner wall of the cabin body.

10. The fully automatic nail decorating machine according to claim 1, wherein control modules are provided in the hand slot mechanism, the visual recognition mechanism, and the printing mechanism.

11. The fully automatic nail decorating machine according to claim 1, wherein the hand slot mechanism further comprises a first thumb slot provided on one side of the one or more finger slots.

12. The fully automatic nail decorating machine according to claim 11, wherein the hand slot mechanism further comprises a second thumb slot provided on another side of the one or more finger slots.

13. The fully automatic nail decorating machine according to claim 12, wherein the hand slot mechanism further comprises a finger placement slot provided on a side of the second thumb slot away from the one or more finger slots.

14. The fully automatic nail decorating machine according to claim 1, further comprising a disinfection mechanism disposed above the hand slot mechanism and comprising a disinfection lamp tube configured to disinfect the hand slot mechanism after finishing nail decorating.

15. The fully automatic nail decorating machine according to claim 1, wherein the hand slot mechanism further comprises a multi-functional plate.

16. The fully automatic nail decorating machine according to claim 1, further comprising a robotic arm disposed inside the cabin body.

17. A nail decorating method of a fully automatic nail decorating machine, applicable to the fully automatic nail decorating machine according to claim 1, wherein the nail decorating method comprises following steps:
S1, resetting all components in the nail decorating machine and opening the cabin door of the cabin body;
S2, informing a user to put one or more fingers into the hand slot mechanism through a voice playback module;
S3, fixing the fingers by actuating a fixing mechanism after a sensor of the hand slot mechanism detects that one or more fingers are put in, performing a first scan by the visual recognition mechanism after the visual recognition mechanism moves to a position above the hand slot mechanism to calculate rotation angles and heights of the one or more fingers, calculating adjustment data and transmitting the adjustment data to the hand slot mechanism to adjust postures of the fingers, performing a second scan to identify whether a nail decorating operating condition is met, informing the user to re-insert one or more fingers to repeat steps S2 to S3 when the nail decorating operating condition is not met, and proceed to next step when the nail decorating operating condition is met;
S4, performing photographing by the visual recognition mechanism to the fingers after the adjustment to the fingers are completed, segmenting nails into nail decorating regions using an algorithm, adjusting sizes and inclinations of nail decorating patterns through an algorithm to associate the nail decorating patterns with nail decorating regions and generate a whole nail decorating patterns, and performing a X-Y-Z three-dimensional coordinate processing in combination with point cloud information of one or more fingers processed by the visual control module to generate nail decorating data and transmit the nail decorating data to the printing mechanism; and
S5, spraying, by the printing nozzles, the nails by controlling the three-way moving module to drive the printing nozzles to move to a position above the hand slot mechanism after the printing mechanism receives the nail decorating data, so as to realize nail decorating;
wherein, in steps S1 to S5, control modules of the hand slot mechanism, of the visual recognition mechanism, and of the printing mechanism are controlled by a main control module, so as to realize movement execution of each of the mechanisms.

18. The nail decorating method of the fully automatic nail decorating machine according to claim 17, wherein the main control module further comprises a safety protection judgment module, wherein data is transmitted to the main control module when the safety protection judgment module detects data abnormality, and each of the mechanisms is controlled to be deactivated or perform protection actions by the main control module.

19. The nail decorating method of the fully automatic nail decorating machine according to claim 17, wherein the nail decorating machine is further provided with a human-computer interaction screen, wherein the nail decorating method comprises:
receiving a nail decorating confirmation signal by the nail decorating machine through the human-computer interaction screen, and generating a nail decorating machine feature code by the human-computer interaction screen;
scanning the human-computer interaction screen by the user using a mobile device to obtain the feature code, binding the user, an order and the nail decorating machine together, and displaying the order in the human-computer interaction screen;
performing a nail decorating operation after the human-machine interaction screen receives order confirmation information.
